(19) United States
(12) Patent Application Publication
(10) Pub. No.: US 2006/0221943 A1
(43) Pub. Date: Oct. 5, 2006

(54) Connecting a packet-based call to multiple devices

(76) Inventors: Justin A. Aborn, Hingham, MA (US); James D. O'Brien JR., East Weymouth, MA (US)

Correspondence Address: FISH & RICHARDSON PC, P.O. BOX 1022, MINNEAPOLIS, MN, 55440-1022, US

(21) Appl. No.: 11/396,353

(22) Filed: Mar. 31, 2006

Related U.S. Application Data
(60) Provisional application No. 60/667,015, filed on Mar. 31, 2005.

(51) Int. Cl. H04L 12/66

(52) U.S. Cl. 370/356

(57) ABSTRACT

A call is received over a packet network, and multiple devices are notified of that call over the packet network. A response is received from a first of the devices and in response a first connection of the call is established to the first of the devices. A message is then received from a second of the devices and in response a second connection of the call is established to the second of the devices.

### CROSS-REFERENCE TO RELATED APPLICATIONS

This application claims the benefit of U.S. Provisional Application No. 60/667,015 filed Mar. 31, 2005.

### BACKGROUND

This description relates to connecting a packet-based call to multiple devices.

In conventional telephone service (plain old telephone service, POTS), particularly in residential service, multiple telephones are typically connected to the same telephone wires in a parallel arrangement. If any of the multiple telephones is engaged in a call, picking up another of the telephones instantly connects it to the on-going call; creating a simple form of three way call. This is the, so called, “party-line” behavior of POTS phones. As an example, an incoming call rings several POTS telephone simultaneously. Two people answer more or less simultaneously. The three parties chat briefly, they determine who the call is for, and then one phone hangs up. The call is left to proceed on most appropriate home phone. The call may even go on to involve a subsequent pickup by a fourth person on a third phone.

Residential Voice-over-IP (VoIP) service is becoming increasingly available. In one architecture of such service, a device at a user's premises provides a gateway between a VoIP connection and a telephone wire connection local to the user's premises to which multiple POTS phones may be connected. When an incoming VoIP call is placed to the gateway, the gateway rings all the phones on the telephone wire. If a second POTS telephone is picked up, it can participate in the call as in traditional POTS service.

A user may have multiple VoIP telephones connected to a local data network at the user's premises. For example, the VoIP telephones may communicate using a wireless Ethernet approach (e.g., IEEE 802.11). A VoIP system may be configured to ring all the VoIP telephones at the user's residence when the user's telephone number is called. The VoIP connection is made to the first telephone that answers. As an example, an incoming call rings several phones simultaneously. Two people attempt to answer more or less simultaneously. The phone answered first connects to the call. The phone answered second hears a dial tone. The call is then typically limited to proceeding on the first phone. A desired called party must come to the first phone, even if another phone is more convenient.

Some VoIP systems can support certain types of multi-party conference calls. For example, multiple VoIP phones can call into a Multipoint Controller Unit (MCU), which establishes the conference call adding each participant when it calls. In another approach, ah-hoc conferences can be established when a participant in a call implements a Multipoint Controller (MC) function. That participant can call a further party and invite them to participate in an ad-hoc conference with the existing participants.

### SUMMARY

In one aspect, in general, an approach to packet-based communication provides the familiar and convenient POTS multiple phone party-line behavior in a packet based environment.

In another aspect, in general, a method includes receiving a call over a packet network. Multiple devices are notified of the call over the packet network. A response is received from a first of the devices and in response a first connection of the call is established to the first of the devices. A message is then received from a second of the devices and in response a second connection of the call is established to the second of the devices.

One or more of the following features can be included.

The call comprises a voice call, such a Voice-over-Internet Protocol (VoIP) call.

The steps are performed according to a Session Initiation Protocol (SIP).

The multiple of devices include at least some VoIP phones.

Notifying the multiple device includes causing the devices to emit notifications of the call, for example, causing the devices to ring. The method can further include, after receiving the response from the first of the devices and before receiving the message from the second of the devices, causing the second of the devices to stop emitting a notification of the call.

Receiving the message from the second of the devices includes receiving an off-hook message.

The method includes registering at least some of the devices, including with the second of the device, to receive the message from the second of the devices.

Receiving the call includes receiving a call directed to destination, the destination being associated with the multiple devices. A specification of the destination can include, for example, a telephone number, a data network address, or a Uniform Resource Indicator.

Establishing the first connection includes responding to a reply to the notifying of the call, for example, from the first device. Establishing the second connection includes responding to message from the second device. For example, responding to the message from the second device can include, for example, responding to a reply to the notifying of the call or responding to an off-hook notification.

Responding to the message from the second device includes establishing a conference involving the first and the second of the devices.

It can be desirable to provide certain familiar or more effective POTS-like phone behavior to users, for example, to ease a transition from POTS to VoIP residential service. Providing such behavior by introducing specific capabilities or functions a packet based service can therefore be desirable, even though packet based phone technology differs from that of POTS phones.

Other features and advantages are apparent from the following description, and from the claims.

### DESCRIPTION

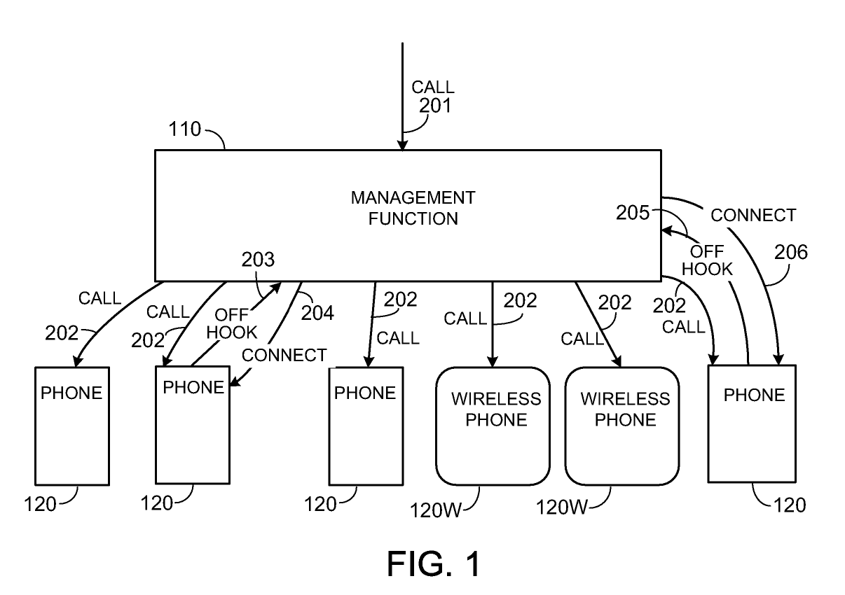

FIG. 1 is a packet-based network.

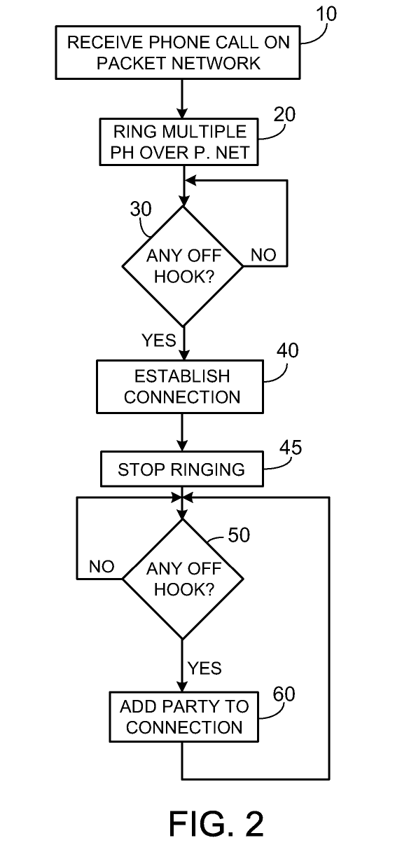

FIG. 2 is a flowchart of adding a connection of a call.

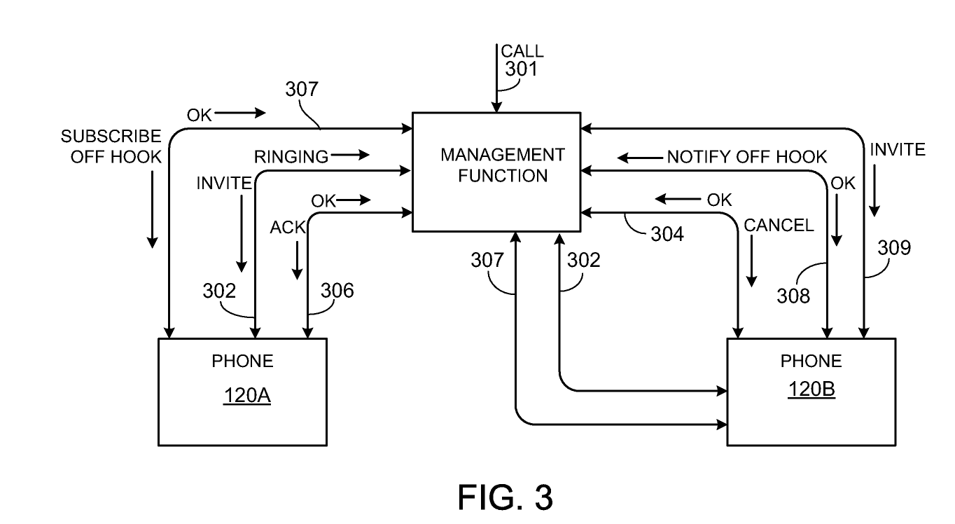

FIG. 3 is an example of party line signaling.

Referring to FIG. 1, a packet network based party line architecture allows Voice over Internet Protocol (VoIP) calls to be placed to a destination and answered by multiple VoIP phones 120 (or equivalent devices) in a “party line” approach that enables multiple VoIP phones to participate in the same call. The architecture has a management function 110 that is used connect calls the VoIP phones, some of which may be wireless devices 120W. The management function may be hosted in a variety of devices, for example, at a device such as a router at a user's residence, or at a more centralized location such as at a cable television “head end” that services a cable modem at the user's residence.

When a packet based voice call 201 is received by the management function 110, the management function places a call 202 to each of the devices 120 that are associated with the destination of the call. For example, all the devices 110 are configured to ring (or otherwise be notified) of VoIP calls placed to a particular address, in which case the management function places a 202 to each of the devices 120. The management function 110 then monitors each device for an answer. The first device to answer goes off hook and sends the notification message 203 to the management function 110. The management function 110 sees the first answer notification message and establishes the connection by sending the connect acknowledge message 204.

While the connection remains established with the first phone that answered, the management function 110 causes the rind notification to terminate at the associated devices 120, but continues to monitor the remaining associated devices 120 for any subsequent off hook notification message, or other type of notification message, that indicates that the associated device should be also connected to the ongoing call. When a next device 120 to answer sends its off hook notification 205, the management function 110 adds the party device to the connection by sending appropriate connection messages 206 to that device. For example, conventional VoIP conferencing capabilities can be used one the management function is aware that the next device should be connected.

FIG. 2. illustrates the method to establish a multiple party line connection in a voice packet network in a flow chart. A packet network voice call is received by the call management function 110 (step 10). All the associated devices are then notified of the call (step 20). The management function waits for an answer in the form of “off hook” message from the answering phone (step 30). The connection is established as the result of the first “off hook” message received in step 30 (step 40) and the management function 110 stops the ringing in the associated devices (step 45). The management function continues to monitor for subsequent answers (step 50). When another phone goes off-hook, the management function adds a party to the call (step 60). Not shown in FIG. 2 is termination of a call when the phones hang up. As each phone hangs up, the management function terminates the connection to that phone, until all the phones hang up.

Referring to FIG. 3, in some examples the management function 110 exchanges sequences of SIP messages 302, 304, 306, 307, 308 with devices 120A and 120B to establish a party line call to both SIP devices. During the initialization, after powering on, the management function 110 exchanges a sequence 307 with devices 120A and 120B. As a result, devices 120A and 120B are each configured to exchange a sequence of messages with the management function 310 to notify the management function 310 anytime they go off hook. When an incoming call 301 is received, the management function 310 exchanges a sequence 302 with devices 120A and 120B, causing both of them to start ringing. When a user answers the call at any device, for example at the device 120A, the answering device 120A exchanges a sequence 306 with the management function 110 and establishes the call. When a call is established, the management function 110 exchanges a sequence 304 with the other devices, here 120B, to stop the ringing. If another user answers at the other device 120B, the device 320B exchanges a sequence 308 to notify the management function 110 it went off hook, too. After the management function 110 exchanges the sequence 308, it sends, for example, a SIP INVITE for a multicast conference, 309 to the device 120B. Thus, both devices 120A and 120B are connected in a VoIP conference and both participate in the call 301.

In some examples, the management function 110 and the associated devices that share the line, 120A and 120B, may communicate using the Media Gateway Control Protocol (MGCP). MGCP devices, such as MGCP phones, generate a notification message for each event that occurs when the phone is operated. Such events can include touching a dial pad key or changing the on/off hook states. With the on/off hook notification generated automatically, the management function 110 does not need to subscribe for the device off hook notification. In this case, the management function 110 establishes VoIP conference connections to associated devices that go off hook while there is a call established to another associated device.

In some examples, the management function 110 and the devices 120 may operate in an arrangement similar to the Private Line Automatic Ring down (PLAR) scheme used in some trading turrets. In this arrangement, the management function statically configures permanent VoIP circuits between devices 120. The permanent VoIP circuits are available, without signaling, immediately, to any device that go off hook. The permanent VoIP circuits are setup in a conference configuration. Thus, the devices 120 are virtually hardwired to each other via the permanent VoIP circuits. A remote call 302 once established to any of the devices 120 is available to all other devices 120 that participate in the PLAR arrangement.

Regardless of the way the devices 120 are connected in the VoIP conference, either through signaling, such as SIP and MGCP, or through static configuration, such as the PLAR scheme, the VoIP conference voice traffic between the end stations is supported in one of the at least two possible ways.

A first alternative is to use multicasting. In multicasting, all devices participating in the VoIP conference, send the VoIP packets to an IP multicast address, made known to each other device through signaling. All devices accept and process the VoIP traffic destined to the multicast address. As exemplified, a SIP INVITE message, such as 309, is used to invite an end device to a multicast conference session. In this case, the Session Description Protocol (SDP) part of the INVITE, specifies the multicast address and the type of media, voice conference.

In a second alternative, the management function 110 and the associated devices 120 communicate using unicast traffic that is mixed (i.e., forking traffic to the phones and merging returning traffic from the phones) by the management unit 110. In this alternative, the management function 110 establishes unicast sessions with each device 120 that goes of hook during an active call, and mixes the voice streams that it receives from the participating devices 120. The management function 110 sends the mixed traffic to each device 120 in a separate unicast session. Thus, all devices 120 may share the line by receiving the same mixed voice traffic and participating in generating the mixed traffic.

In some examples, the management function is hosted in a management unit, which may be implemented locally in a LAN component. It may be located in one of an end device, which takes the role of a master device. It may be located in a local router. In some examples, the management unit is implemented in a remote location, accessible over a WAN. For example it may be located in a service provider (ISP) access router. The management function can be implemented in software, for example, for execution on a general purpose or a special purpose processor.

Regardless of its physical location the management unit may support several VoIP protocols and provide the party line function to devices of different type. Thus SIP phones, MGCP phones and PLAR configured phones may share the same line.

Although described in the context of voice (e.g., VoIP) calls, the approach is applicable to other types of calls, such as video, multimedia, and text (e.g., instant messaging) calls. The approach is also not limited to Internet Protocol (IP) networks.

Components of the system, such as the management unit, may be implemented in hardware, in software, or a combination of hardware and software. The software can include instructions for a processor, such as a general purpose microprocessor. The software may be stored on a computer-readable medium, such as in a solid-state memory, or may be provided over a network (e.g., embodied on a signal propagating over a communication medium of the network).

It is to be understood that the foregoing description is intended to illustrate and not to limit the scope of the invention, which is defined by the scope of the appended claims. Other embodiments are within the scope of the following claims.

What is claimed is:

1. A method comprising:
receiving a call over a packet based network;
notifying a plurality of devices of the call over the packet network;
receiving a response from a first of the devices and in response establishing a first connection of the call to the first of the devices; and
receiving a message from a second of the devices and in response establishing a second connection of the call to the second of the devices.

2. The method of claim 1 wherein the call comprises a voice call.

3. The method of claim 2 wherein the voice call comprises a Voice-over-Internet Protocol (VoIP) call.

4. The method of claim 2 wherein the steps are performed according to a Session Initiation Protocol (SIP).

5. The method of claim 1 wherein the plurality of devices includes at least some VoIP phones.

6. The method of claim 1 wherein notifying the plurality of devices includes causing the devices to emit notifications of the call.

7. The method of claim 5 wherein the method further comprises, after receiving the response from the first of the devices and before receiving the message from the second of the devices, causing the second of the devices to stop emitting a notification of the call.

8. The method of claim 1 wherein receiving the message from the second of the devices includes receiving an off-hook message.

9. The method of claim 1 wherein the method further includes registering at least some of the devices, including with the second of the device, to receive the message from the second of the devices.

10. The method of claim 1 wherein receiving the call includes receiving a call directed to destination, the destination being associated with the plurality of devices.

11. The method of claim 10 wherein a specification of the destination includes a telephone number.

12. The method of claim 10 wherein a specification of the destination includes a data network address.

13. The method of claim 10 wherein a specification of the destination includes a Uniform Resource Indicator.

14. The method of claim 1 wherein establishing the first connection includes responding to a reply to the notifying of the call.

15. The method of claim 14 wherein establishing the second connection includes responding to message from the second device.

16. The method of claim 15 wherein responding to the message from the second device includes responding to a reply to the notifying of the call.

17. The method of claim 15 wherein responding to the message from the second device includes responding to an off-hook notification.

18. The method of claim 15 wherein responding to the message from the second device includes establishing a conference involving the first and the second of the devices.

19. An apparatus comprising:
an interface for connecting to a call control module configured to
receive a call via a packet based network;
notify a plurality of devices of the call via the packet network;
receive a response from a first of the devices and in response establish a first connection of the call to the first of the devices; and
receive a message from a second of the devices and in response establish a second connection of the call to the second of the devices.

20. Software stored on a computer-readable media comprising instructions for causing a processing system to:
receive a call via a packet based network;
notify a plurality of devices of the call via the packet network;
receive a response from a first of the devices and in response establish a first connection of the call to the first of the devices; and
receive a message from a second of the devices and in response establish a second connection of the call to the second of the devices.
